(19) United States
(12) Patent Application Publication
(10) Pub. No.: US 2025/0285418 A1
(43) Pub. Date: Sep. 11, 2025

(54) DOMAIN ADAPTATION THROUGH MODEL PRUNING

(71) Applicant: Cisco Technology, Inc., San Jose, CA (US)

(72) Inventors: Yuzhang Shang, Chicago, IL (US); Yuguang Yao, East Lansing, MI (US); Yingjun Du, Amsterdam (NL); Gaowen Liu, Naperville, IL (US); Ali Payani, Cupertino, CA (US); Ramana Rao V.R. Kompella, Foster City, CA (US)

(73) Assignee: Cisco Technology, Inc., San Jose, CA (US)

(21) Appl. No.: 18/598,148

(22) Filed: Mar. 7, 2024

(51) Int. Cl. G06V 10/774; G06V 10/776; G06V 10/778

(52) U.S. Cl. CPC G06V 10/7753; G06V 10/776; G06V 10/7788

(57) ABSTRACT

In one implementation, a device receives, via a user interface, a selection of a labeled training dataset and a selection of an unlabeled training dataset, wherein the unlabeled training dataset is captured from a target domain. The device forms a domain-adapted training dataset by pruning the labeled training dataset based on the unlabeled training dataset. The device trains a machine learning model using the domain-adapted training dataset. The device prunes the machine learning model to form a domain-adapted model for the target domain.

### TECHNICAL FIELD

The present disclosure relates generally to domain adaptation through model pruning.

### BACKGROUND

With the advents of machine and deep learning, video analytics systems have grown in both their capabilities, as well as their complexities. One use for such systems exists in the context of multi-camera surveillance systems, to detect people and other objects and make decisions about their behaviors. For instance, a surveillance system in an airport or other sensitive area may seek to detect when a person leaves an object unattended. Example tasks in the realm of video analytics include, but are not limited to, classification tasks, re-identification tasks, and object detection tasks.

In computer vision, domain shift refers to a situation where there is a difference or mismatch between the distribution of data used to train a model and the distribution of data encountered during its deployment or testing in real-world scenarios. This shift can occur due to variations in image properties, such as lighting conditions, camera perspectives, object appearances, or environmental factors.

Domain shift poses a challenge because the model may not generalize well to unseen data from the target domain if it has only been trained on a different source domain. The performance of a computer vision model can significantly degrade when faced with a domain shift, leading to decreased model accuracy and reliability in real-world situations.

### BRIEF DESCRIPTION OF THE DRA WINGS

The implementations herein may be better understood by referring to the following description in conjunction with the accompanying drawings in which like reference numerals indicate identically or functionally similar elements, of which:

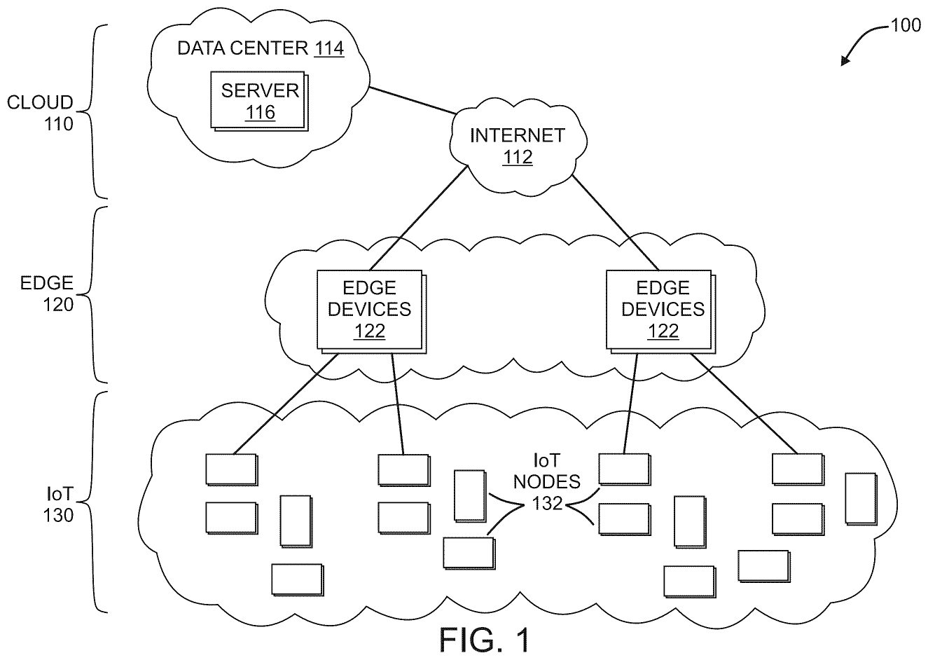

FIG. 1 illustrate an example network;

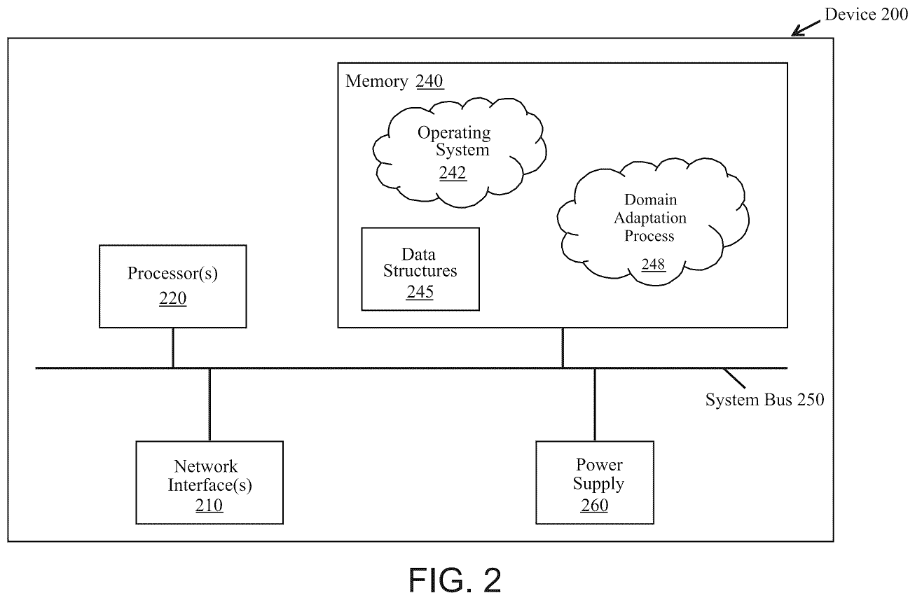

FIG. 2 illustrates an example network device/node;

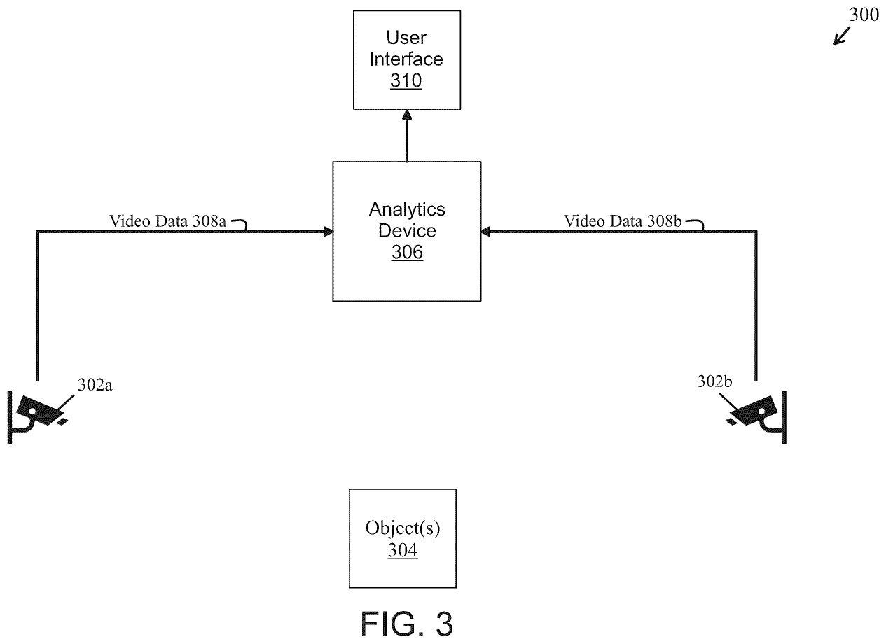

FIG. 3 illustrates an example system for performing video analytics;

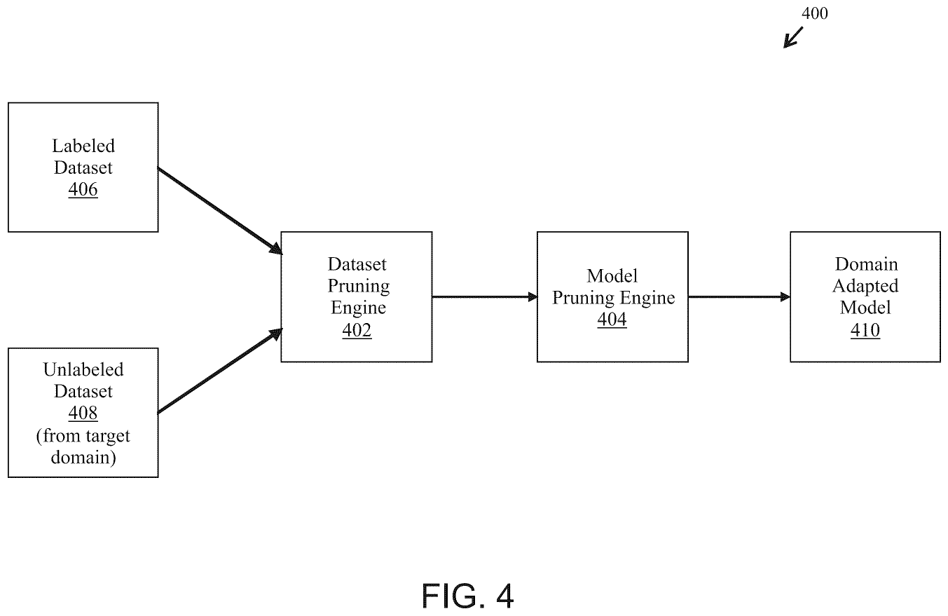

FIG. 4 illustrates an example architecture for domain adaptation via model pruning;

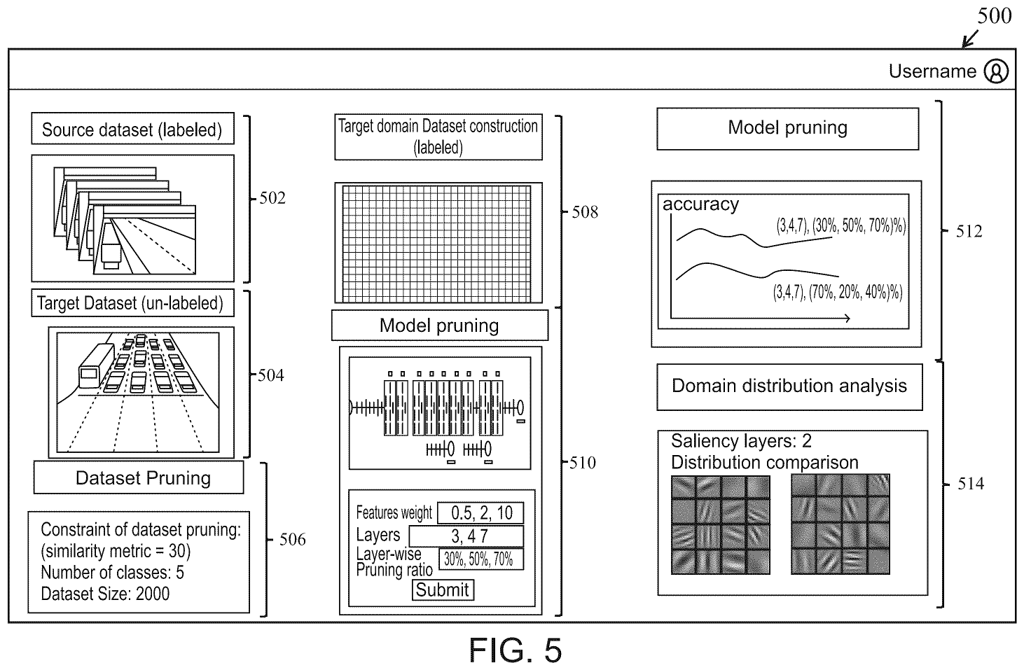

FIG. 5 illustrates an example user interface for performing domain adaptation; and

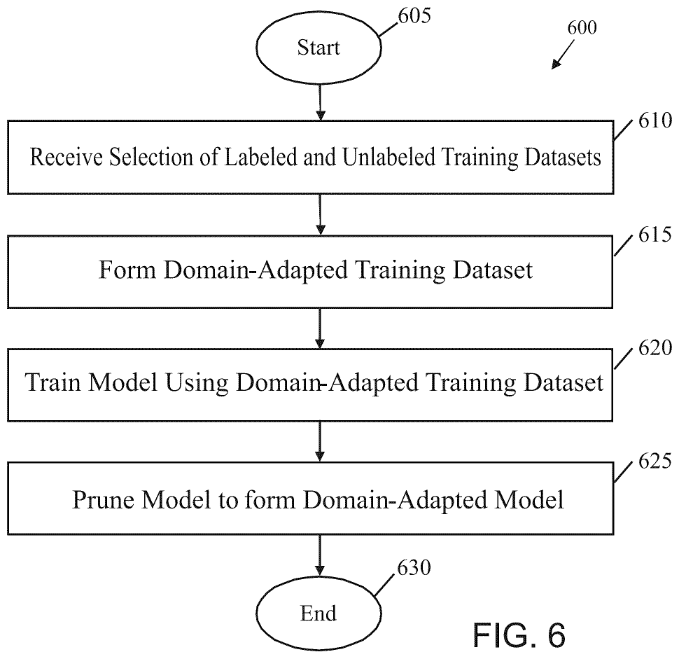

FIG. 6 illustrates an example simplified procedure for domain adaptation via model pruning.

### DESCRIPTION OF EXAMPLE IMPLEMENTATIONS

### Overview

According to one or more implementations of the disclosure, a device receives, via a user interface, a selection of a labeled training dataset and a selection of an unlabeled training dataset, wherein the unlabeled training dataset is captured from a target domain. The device forms a domain-adapted training dataset by pruning the labeled training dataset based on the unlabeled training dataset. The device trains a machine learning model using the domain-adapted training dataset. The device prunes the machine learning model to form a domain-adapted model for the target domain.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. Other types of networks, such as field area networks (FANs), neighborhood area networks (NANs), personal area networks (PANs), etc. may also make up the components of any given computer network.

In various implementations, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or wired networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Edge computing, also sometimes referred to as “fog” computing, is a distributed approach of cloud implementation that acts as an intermediate layer from local networks (e.g., IoT networks) to the cloud (e.g., centralized and/or shared resources, as will be understood by those skilled in the art). That is, generally, edge computing entails using devices at the network edge to provide application services, including computation, networking, and storage, to the local nodes in the network, in contrast to cloud-based approaches that rely on remote data centers/cloud environments for the services. To this end, an edge node is a functional node that is deployed close to IoT endpoints to provide computing, storage, and networking resources and services. Multiple edge nodes organized or configured together form an edge compute system, to implement a particular solution. Edge nodes and edge systems can have the same or complementary capabilities, in various implementations. That is, each individual edge node does not have to implement the entire spectrum of capabilities. Instead, the edge capabilities may be distributed across multiple edge nodes and systems, which may collaborate to help each other to provide the desired services. In other words, an edge system can include any number of virtualized services and/or data stores that are spread across the distributed edge nodes. This may include a master-slave configuration, publish-subscribe configuration, or peer-to-peer configuration.

Low power and Lossy Networks (LLNs), e.g., certain sensor networks, may be used in a myriad of applications such as for “Smart Grid” and “Smart Cities.” A number of challenges in LLNs have been presented, such as:
1) Links are generally lossy, such that a Packet Delivery Rate/Ratio (PDR) can dramatically vary due to various sources of interferences, e.g., considerably affecting the bit error rate (BER);
2) Links are generally low bandwidth, such that control plane traffic must generally be bounded and negligible compared to the low rate data traffic;
3) There are a number of use cases that require specifying a set of link and node metrics, some of them being dynamic, thus requiring specific smoothing functions to avoid routing instability, considerably draining bandwidth and energy;
4) Constraint-routing may be required by some applications, e.g., to establish routing paths that will avoid non-encrypted links, nodes running low on energy, etc.;
5) Scale of the networks may become very large, e.g., on the order of several thousands to millions of nodes; and
6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

FIG. 1 is a schematic block diagram of an example simplified computer network 100 illustratively comprising nodes/devices at various levels of the network, interconnected by various methods of communication. For instance, the links may be wired links or shared media (e.g., wireless links, wired links, etc.) where certain nodes, such as, e.g., routers, sensors, computers, etc., may be in communication with other devices, e.g., based on connectivity, distance, signal strength, current operational status, location, etc.

Specifically, as shown in the example IoT network 100, three illustrative layers are shown, namely cloud layer 110, edge layer 120, and IoT device layer 130. Illustratively, the cloud layer 110 may comprise general connectivity via the Internet 112, and may contain one or more datacenters 114 with one or more centralized servers 116 or other devices, as will be appreciated by those skilled in the art. Within the edge layer 120, various edge devices 122 may perform various data processing functions locally, as opposed to datacenter/cloud-based servers or on the endpoint IoT nodes 132 themselves of IoT device layer 130. For example, edge devices 122 may include edge routers and/or other networking devices that provide connectivity between cloud layer 110 and IoT device layer 130. Data packets (e.g., traffic and/or messages sent between the devices/nodes) may be exchanged among the nodes/devices of the computer network 100 using predefined network communication protocols such as certain known wired protocols, wireless protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the network 100 is merely an example illustration that is not meant to limit the disclosure.

Data packets (e.g., traffic and/or messages) may be exchanged among the nodes/devices of the computer network 100 using predefined network communication protocols such as certain known wired protocols, wireless protocols (e.g., IEEE Std. 802.15.4, Wi-Fi, Bluetooth®, DECT-Ultra Low Energy, LoRa, etc.), or other shared-media protocols where appropriate. In this context, a protocol consists of a set of rules defining how the nodes interact with each other.

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more network interfaces 210 (e.g., wired, wireless, etc.), at least one processor 220, and a memory 240 interconnected by a system bus 250, as well as a power supply 260 (e.g., battery, plug-in, etc.).

Network interface(s) 210 include the mechanical, electrical, and signaling circuitry for communicating data over links coupled to the network. The network interfaces 210 may be configured to transmit and/or receive data using a variety of different communication protocols, such as TCP/IP, UDP, etc. Note that the device 200 may have multiple different types of network connections, e.g., wireless and wired/physical connections, and that the view herein is merely for illustration.

The memory 240 comprises a plurality of storage locations that are addressable by the processor 220 and the network interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes/services may comprise an illustrative domain adaptation process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

In various implementations, domain adaptation process 248 employ one or more supervised, unsupervised, or semi-supervised machine learning models. Generally, supervised learning entails the use of a training set of data, as noted above, that is used to train the model to apply labels to the input data. For example, the training data may include sample images or other video data that depict certain types of objects or behaviors and are labeled as such. On the other end of the spectrum are unsupervised techniques that do not require a training set of labels. Notably, while a supervised learning model may look for previously seen patterns that have been labeled, an unsupervised model may instead look to whether there are sudden changes in the behavior. Semi-supervised learning models take a middle ground approach that uses a greatly reduced set of labeled training data.

Example machine learning techniques that domain adaptation process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) ANNs (e.g., for non-linear models), replicating reservoir networks (e.g., for non-linear models, typically for time series), random forest classification, or the like.

In further embodiments, domain adaptation process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, process 248 may use a generative model to generate synthetic network traffic based on existing user traffic to test how the network reacts. Example generative approaches can include, but are not limited to, generative adversarial networks (GANs), large language models (LLMs), other transformer models, and the like.

The performance of a machine learning model can be evaluated in a number of ways based on the number of true positives, false positives, true negatives, and/or false negatives of the model. For example, the false positives of the model may refer to the number of times the model incorrectly detected a particular type of object in a video. Conversely, the false negatives of the model may refer to the number of times the model failed to detect that type of object in the video. True negatives and positives may refer to the number of times the model correctly performed its video analytics task, either in the negative or positive sense (e.g., correctly determining that the object type was not present in the video or was present). Thus, the accuracy of the model may correspond to the ratio of true positives to total assessments made by the model. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

FIG. 3 illustrates an example system 300 for performing video analytics, as described in greater detail above. As shown, there may be any number of cameras 302 deployed to a physical area, such as cameras 302a-302b. Such surveillance is now fairly ubiquitous across various locations including, but not limited to, public transportation facilities (e.g., train stations, bus stations, airports, etc.), entertainment facilities (e.g., sports arenas, casinos, theaters, etc.), schools, office buildings, and the like. In addition, so-called “smart” cities are also now deploying surveillance systems for purposes of monitoring vehicular traffic, crime, and other public safety events.

Regardless of the deployment location, cameras 302a-302b may generate and send video data 308a-308b, respectively, to an analytics device 306 (e.g., a device executing a machine learning model trained to perform a video analytics task). For instance, analytics device 306 may be an edge device (e.g., an edge device 122 in FIG. 1), a remote server (e.g., a server 116 in FIG. 1), or may even take the form of a particular endpoint in the network, such as a dedicated analytics device, a particular camera 302, or the lie.

In general, analytics device 306 may be configured to provide video data 308a-308b for display to one or more user interfaces 310, as well as to analyze the video data for events that may be of interest to a potential user. To this end, analytics device 306 may perform a video analytics task or set of tasks on video data 308a-308b. For instance, such video analytics tasks may include any or all of the following:
Image classification—i.e., recognizing what a particular image represents
Re-identification—i.e., recognizing that a depicted object is the same across different portions of video and/or video feeds (e.g., a person walks around a corner, transitioning from the video feed of one camera to another)·
Object detection—i.e., detecting the presence of certain types of objects in the video (e.g., vehicles, people, etc.)
Etc.

As noted above, though, video analytics systems that rely on artificial intelligence/machine learning are often subject to domain shift, whereby there is a difference or mismatch between the distribution of data used to train a model and the distribution of data encountered during its deployment or testing in real-world scenarios. This shift can occur due to variations in image properties, such as lighting conditions, camera perspectives, object appearances, environmental factors, or the like. Consequently, the performance of the model once deployed will be degraded. Indeed, domain shift poses a challenge because the model may not generalize well to unseen data from the target domain/deployment environment, if it has only been trained on a different source domain.

There are various reasons why domain shift can lead to poor model accuracy when such as the following, among others:
Viewpoint bias—In some cases, the training dataset may capture video at different angles than that of the target domain, which could lead to poor model performance. For instance, the source training data may be captured by a camera at a downward angle, whereas the camera capturing video in target domain may do so more parallel to the ground.
Style bias—As would be appreciated, clothing, vehicles, and other objects, may differ in appearance based on their geographic locations, thereby leading the deployed model to be unable to reliably identify objects, events, and the like, in the target domain. For instance, people in Singapore may dress differently than that of people in Iceland, leading to inherent bias in the trained model.
Background—Another factor that may affect the performance of a model relates to differences in the backgrounds between that of the target domain and the training dataset. For instance, if the model is trained using training data captured in an urban area, but deployed to a suburban area, this could lead to poor model performance.
Etc.

### Domain Adaptation Through Model Pruning

The techniques introduced herein aid in the adaptation of a machine learning model for use in a specific, target domain (e.g., the location or locations from which the input data is captured for the model). In some aspects, the techniques herein first prune the training dataset, to adapt it to the target domain. In turn, the techniques herein also prune the resulting model, thereby further adapting it for use in the target domain.

Illustratively, the techniques described herein may be performed by hardware, software, and/or firmware, such as in accordance with the domain adaptation process 248, which may include computer executable instructions executed by the processor 220 (or independent processor of interfaces 210), to perform functions relating to the techniques described herein.

Specifically, according to various implementations, a device receives, via a user interface, a selection of a labeled training dataset and a selection of an unlabeled training dataset, wherein the unlabeled training dataset is captured from a target domain. The device forms a domain-adapted training dataset by pruning the labeled training dataset based on the unlabeled training dataset. The device trains a machine learning model using the domain-adapted training dataset. The device prunes the machine learning model to form a domain-adapted model for the target domain.

Operationally, one observation herein is that different layers of a neural network (or other machine learning model) learn different types of features. For instance, consider a neural network trained to analyze video or image data, to perform object detection. In such a case, the first convolutional layer(s) of the neural network may be trained to first detect features such as edges and simple textures. Later convolutional layers of the model may learn other features such as more complex textures and patterns. Finally, the last convolutional layers may learn features such as objects or parts of objects. The fully connected layers learn to connect the activations from the high-level features to the individual classes to be predicted (e.g., specific types of objects depicted in the input video or image data).

The techniques herein propose a search and pruning solution to the training dataset thereby constructing a labeled dataset that has minimal data bias with respect to the target dataset (e.g., a dataset collected from the target domain). Then, pruning models are based on the constructed dataset to solve the domain adaptation problem. Different domains can also be described by a sub-neural network. As would be appreciated, the techniques herein are also label-free and do not require any model fine-tuning.

In various implementations, FIG. 4 illustrates an example architecture 400 for domain adaptation via model pruning. As shown, domain adaptation process 248 may include and/or process any or all of the following components: a dataset pruning engine 402, a model pruning engine 404, a labeled dataset 406, and/or an unlabeled dataset 408, that operate in conjunction to produce a domain adapted model 410. As would be appreciated, these components may be combined or omitted as desired. In addition, these components may be executed in a distributed manner across multiple devices, in which case the combination of executing devices may be viewed as a singular device for purposes of the teachings herein.

During execution, dataset pruning engine 402 may take as input labeled dataset 406, which may take the form of sensor data that has been labeled as indicative of different classes on which a classification model may be trained. For instance, labeled dataset 406 may take the form of video data, image data, audio data, or the like, that have been labeled as depicting the presence of specific types of objects or events. In some instances, labeled dataset 406 may be a general training dataset that includes data captured from any number of environments or domains that differ from that of the target domain (e.g., ImageNet data, COCO data, etc.).

In some cases, dataset pruning engine 402 may also take as input a selected unlabeled dataset 408 from the target domain. For instance, in the case of the model being deployed to assess video data captured by a specific camera, unlabeled dataset 408 may include video data captured by that camera. Here, a key aspect of the techniques herein is that unlabeled dataset 408 does not require any labeling by users, to produce domain adapted model 410 for deployment to analyze the video data from the target camera.

In various implementations, dataset pruning engine 402 may perform dataset pruning based on labeled dataset 406 and unlabeled dataset 408, to form a training dataset that has been adapted to the target domain. To do so, assume that there is a classification task f as follows:
f:Rⁿ→C,C={1, . . . , k}

In addition, let labeled dataset 406 be represented as DI as follows:
Labeled Dataset Dₗ:(X, y) where XϵRⁿ and ϵC

Also, let unlabeled dataset 408 be represented as Dᵤ as follows:
Unabeled Dataset Dᵤ:(X) where XϵRⁿ

In general, dataset pruning engine 402 may seek to find a subset of Dₗ where its distribution is aligned with Dᵤ. To do so, dataset pruning engine 402 may employ either of two approaches: a parametric approach or a non-parametric approach.

Under the parametric approach, dataset pruning engine 402 may fit a parametric distribution for XϵRⁿ and selecting a subset of Dₗ, based on its probability under the fitted distribution, if there is sufficient information about the nature of data in Dₗ and Dᵤ. For instance, assume that d_{θ} is such a distribution, for instance a Gaussian distribution existing in Rⁿ, whereby the parameter set includes θ={meanϵRⁿ, covariance\R^{ncn}. Dataset pruning engine 402 can perform this fitting using any suitable statistical approach such as maximum likelihood estimate or the like. Given d}_{θ} and Dₗ, dataset pruning engine 402 can then assign a probability to any sample in Dₗ, according to d_{θ}. With this probability, dataset pruning engine 402 can then pick a subset of Dₗ that aligns well with the distribution of Dᵤ.

While the parametric approach above is very fast and reliable, it also requires apriori knowledge about the distribution and that the distribution is not too complex. However, in many real-life scenarios (e.g., image processing), the parametric approach may not work well, since the distribution can be very complex. Even if dataset pruning engine 402 were to parameterize the distribution using a neural network, it may still overfit and give and give incorrect results. Accordingly, dataset pruning engine 402 may instead use a non-parametric approach, in some instances.

One potential non-parametric approach may rely on Covariate Shift Adaptation, which requires training a model on Dₗ and creating pseudo labels for Dᵤ, then training a binary classifier to discriminate between the two datasets (e.g., similar to the discriminators in a GAN architecture). However, this approach is also very costly and may not be suitable, depending on the situation.

In further implementations, dataset pruning engine 402 may instead employ a kNN-based, non-parametric approach. More specifically, assume that a model has already been trained using labeled dataset 406 (Dₗ), dataset pruning engine 402 can use the feature space for that model for the samples from unlabeled dataset 408 (Dᵤ) to find those that are better aligned with Dₗ. This, however, limits the usability of the adaptation technique and, for different downstream tasks, this alignment might not be perfect.

In turn, dataset pruning engine 402 may use kNN clustering on each sample in Dᵤ to find the closest sample in Dₗ. Alternatively, dataset pruning engine 402 may rank the samples in Dₗ according to their distance to the closest sample in Dᵤ. This provides a ranking mechanism that dataset pruning engine 402 can combine with the importance sampling information, to find the most relevant subset of Dₗ.

For a measure of distance, dataset pruning engine 402 may use any suitable distance measurement, such as the Euclidean distance between the feature layer representation of each sample, given a pretrained model over Dₗ. This feature space is much smaller in size and can be utilized for fast kNN searching.

Regardless of whether dataset pruning engine 402 uses a parametric or non-parametric approach, dataset pruning engine 402 may output a subset of labeled dataset 406 that has been adapted to the target domain. In turn, model pruning engine 404 may use this dataset to produce domain adapted model 410.

In some implementations, model pruning engine 404 may perform model pruning to form domain adapted model 410 using a layer-wise sparsity ratio. Here, such pruning ratios may be predefined on a per-layer basis, allowing model pruning engine 404 to train a machine learning model using the domain adapted dataset from dataset pruning engine 402 and perform pruning on it, to generate domain adapted model 410. For instance, such sparsity ratio may be defined by policy or specified via a user interface.

More specifically, let c^{l}ϵ{0, 1} denote a mask on w^{l}. In such a case, the pruned network is given by the following:
f(c^{l}⊙w^{l}, . . . ,c^{L}⊙w^{L};x)

In such a case, model pruning engine 404 may scale the sparsity of the convolutional layer proportional to:

$$1 - \frac{{n}^{l - 1} + {n}^{l} + {w}^{l} + {h}^{l}}{{n}^{l - 1} \times {n}^{l} \times {w}^{l} + {h}^{l}}$$

where n^{l} refers to the number of neurons/channels in n^{l-1}+n^{l}+w^{l}+h^{l} layer l, with w^{l} and h^{l} referring to the width and height, respectively.

Once domain adapted model 410 is generated, the system may deploy it for use to analyze data from one or more sources located at the target domain. For instance, domain adapted model 410 may be deployed to an edge device or other device located at the target domain and configured to ingest sensor data (e.g., video data, etc.) from any number of sensors. In other instances, domain adapted model 410 may be deployed to the cloud or other central location, in which case an edge device at the target domain may send the data to domain adapted model 410 in the cloud for analysis.

FIG. 5 illustrates an example user interface 500 for performing domain adaptation, in accordance with the teachings herein. As shown, domain adaptation process 248 may interact with user interface 500, to allow an administrator or other user to specify how the system generates the domain adapted model. For instance, user interface 500 may include an input selection 502 that allows a user to specify the source dataset that has been previously labeled (e.g., labeled dataset 406 in FIG. 4) and an input selection 504 to select an unlabeled dataset captured in the target domain. In some implementations, user interface 500 may also be configured to provide one or more samples from the selected datasets for review by the user.

In addition, user interface 500 may include a selection 506 that allows the user to specify one or more parameters for the dataset pruning. For instance, the user may be able to specify the similarity metric, number of classes, dataset size, or the like, that dataset pruning engine 402 uses to prune the labeled dataset specified via input selection 502 based on the unlabeled dataset from the target domain specified via input selection 504. In one implementation, user interface 500 may provide a sampling of the resulting dataset for review by the user, as well. The user can then review the target domain dataset and opt to either adjust the input datasets or opt to begin the model pruning functions.

User interface 500 may also include inputs 510 to initiate the functions of model pruning engine 404 using the domain adapted dataset. In some instances, as shown, user interface 500 may display a representation of the model being pruned. In addition, inputs 510 may allow the user to specify parameters to control the functions of model pruning engine 404. For instance, the user may be able to specify the feature weight(s), layer(s), layer-wise pruning ratio(s), or the like, that model pruning engine 404 uses to prune the model.

In some instances, user interface 500 may also display information 512 indicative of the performance of the resulting, domain-adapted model. For instance, information 512 may take the form of a comparison of an accuracy of the domain-adapted model to that of the base machine learning model (e.g., by using a testing dataset from the target domain). User interface 500 may also display information 514 regarding the domain distribution. For instance, information 514 may show the saliency layers and a comparison of the distributions for review.

FIG. 6 illustrates an example simplified procedure 600 (e.g., a method) for domain adaptation via model pruning, in accordance with one or more implementations described herein. For example, a non-generic, specifically configured device (e.g., device 200), such as an edge device, a server, or other device in a network, may perform procedure 600 by executing stored instructions (e.g., domain adaptation process 248). The procedure 600 may start at step 605, and continues to step 610, where, as described in greater detail above, the device may receive, via a user interface, a selection of a labeled training dataset and a selection of an unlabeled training dataset, wherein the unlabeled training dataset is captured from a target domain. In various implementations, the labeled training dataset comprises video data labeled with classification labels indicative of at least one of: types of objects depicted in the video data or events depicted in the video data. In some cases, the labeled training dataset comprises data captured at least in part at a location that differs from that of the target domain.

At step 615, as detailed above, the device may form a domain-adapted training dataset by pruning the labeled training dataset based on the unlabeled training dataset. In some implementations, the device may also provide, and to the user interface, samples of the domain-adapted training dataset for display.

At step 620, the device may train a machine learning model using the domain-adapted training dataset, as described in greater detail above. As would be appreciated, doing so helps to improve the performance of the resulting model, rather than relying on the full set of labeled training data, which may include certain biases.

At step 625, as detailed above, the device may prune the machine learning model to form a domain-adapted model for the target domain. In some implementations, the device uses a parametric approach to prune the labeled training dataset based on the unlabeled training dataset. In other implementations, the device uses a non-parametric approach to prune the labeled training dataset based on the unlabeled training dataset. In one implementation, the device may receive, via the user interface, layer-wise pruning ratios, and prune the machine learning model according to the layer-wise pruning ratios. In some instances, the device may also provide, to the user interface, a comparison of an accuracy of the domain-adapted model to that of the machine learning model. The device may also deploy the domain-adapted model to an edge device in the target domain. In some cases, the domain-adapted model assesses sensor data captured in the target domain.

Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for domain adaptation through model pruning, it is to be understood that various other adaptations and modifications may be made within the spirit and scope of the implementations herein. For example, while certain implementations are described herein with respect to specific use cases for the techniques herein, the techniques can be extended without undue experimentation to other use cases, as well.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof, that cause a device to perform the techniques herein. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method comprising:
receiving, at a device and via a user interface, a selection of a labeled training dataset and a selection of an unlabeled training dataset, wherein the unlabeled training dataset is captured from a target domain;
forming, by the device, a domain-adapted training dataset by pruning the labeled training dataset based on the unlabeled training dataset;
training, by the device, a machine learning model using the domain-adapted training dataset; and
pruning, by the device, the machine learning model to form a domain-adapted model for the target domain.

2. The method as in claim 1, wherein the labeled training dataset comprises video data labeled with classification labels indicative of at least one of: types of objects depicted in the video data or events depicted in the video data.

3. The method as in claim 1, wherein the device uses a parametric approach to prune the labeled training dataset based on the unlabeled training dataset.

4. The method as in claim 1, wherein the device uses a non-parametric approach to prune the labeled training dataset based on the unlabeled training dataset.

5. The method as in claim 1, further comprising:
receiving, at the device and via the user interface, layer-wise pruning ratios, wherein the device prunes the machine learning model according to the layer-wise pruning ratios.

6. The method as in claim 1, further comprising:
providing, by the device and to the user interface, samples of the domain-adapted training dataset for display.

7. The method as in claim 1, wherein the labeled training dataset comprises data captured at least in part at a location that differs from that of the target domain.

8. The method as in claim 1, further comprising:
providing, by the device and to the user interface, a comparison of an accuracy of the domain-adapted model to that of the machine learning model.

9. The method as in claim 1, further comprising:
deploying, by the device, the domain-adapted model to an edge device in the target domain.

10. The method as in claim 9, wherein the domain-adapted model assesses sensor data captured in the target domain.

11. An apparatus, comprising:
a network interface to communicate with a computer network;
a processor coupled to the network interface and configured to execute one or more processes; and
a memory configured to store a process that is executed by the processor, the process when executed configured to:
receive, via a user interface, a selection of a labeled training dataset and a selection of an unlabeled training dataset, wherein the unlabeled training dataset is captured from a target domain;
form a domain-adapted training dataset by pruning the labeled training dataset based on the unlabeled training dataset;
train a machine learning model using the domain-adapted training dataset; and
prune the machine learning model to form a domain-adapted model for the target domain.

12. The apparatus as in claim 11, wherein the labeled training dataset comprises video data labeled with classification labels indicative of at least one of: types of objects depicted in the video data or events depicted in the video data.

13. The apparatus as in claim 11, wherein the apparatus uses a parametric approach to prune the labeled training dataset based on the unlabeled training dataset.

14. The apparatus as in claim 11, wherein the apparatus uses a non-parametric approach to prune the labeled training dataset based on the unlabeled training dataset.

15. The apparatus as in claim 11, wherein the process when executed is further configured to:
receive, via the user interface, layer-wise pruning ratios, wherein the apparatus prunes the machine learning model according to the layer-wise pruning ratios.

16. The apparatus as in claim 11, wherein the process when executed is further configured to:
provide, to the user interface, samples of the domain-adapted training dataset for display.

17. The apparatus as in claim 11, wherein the labeled training dataset comprises data captured at least in part at a location that differs from that of the target domain.

18. The apparatus as in claim 11, wherein the process when executed is further configured to:
provide, to the user interface, a comparison of an accuracy of the domain-adapted model to that of the machine learning model.

19. The apparatus as in claim 11, wherein the process when executed is further configured to:
deploy the domain-adapted model to an edge device in the target domain.

20. A tangible, non-transitory, computer-readable medium storing program instructions that cause a device to execute a process comprising:
receiving, at the device and via a user interface, a selection of a labeled training dataset and a selection of an unlabeled training dataset, wherein the unlabeled training dataset is captured from a target domain;
forming, by the device, a domain-adapted training dataset by pruning the labeled training dataset based on the unlabeled training dataset;
training, by the device, a machine learning model using the domain-adapted training dataset; and
pruning, by the device, the machine learning model to form a domain-adapted model for the target domain.
